(19) United States
(12) Patent Application Publication
(10) Pub. No.: US 2023/0318085 A1
(43) Pub. Date: Oct. 5, 2023

(54) BATTERY UNIT

(71) Applicant: HONDA MOTOR CO., LTD., Tokyo (JP)

(72) Inventors: Hiroki SAKAMOTO, Tokyo (JP); Jaewon SON, Tokyo (JP); Toshiyuki IKEUCHI, Tokyo (JP); Yuki KAGAWA, Osaka City (JP)

(73) Assignee: HONDA MOTOR CO., LTD., Tokyo (JP)

(21) Appl. No.: 18/126,683

(22) Filed: Mar. 27, 2023

(30) Foreign Application Priority Data
Mar. 30, 2022 (JP) 2022-057585

(51) Int. Cl. H01M 10/6563; H01M 50/204; H01M 50/249; H01M 10/613; H01M 10/625; H01M 10/6566

(52) U.S. Cl. CPC H01M 10/6563; H01M 10/613; H01M 10/625; H01M 10/6566; H01M 50/204; H01M 50/249; B60L 50/64; H01M 2220/20

(57) ABSTRACT

A battery unit mounted on a vehicle includes a case having an intake port, a battery module which is disposed inside the case and in which a plurality of battery cells are stacked, a fan disposed inside the case and blowing cooling air to the battery module, and an intake duct connecting the intake port and the fan. The intake duct includes a first flow path extending along a first surface of the battery module, and a second flow path extending along a second surface different from the first surface of the battery module.

### CROSS-REFERENCE TO RELATED APPLICATIONS

This application is based on and claims priority under 35 USC 119 from Japanese Patent Application No. 2022-057585 filed on Mar. 30, 2022.

### TECHNICAL FIELD

The present disclosure relates to a battery unit mounted on an electric vehicle or the like.

### BACKGROUND ART

In recent years, researches and development on secondary batteries which contribute to improvement in efficiency of energy have been carried out to secure an access to affordable, reliable, sustainable, and modem energy for more people.

With the electrification of the drive source of the vehicle, the vehicle is mounted with a battery unit having a large capacity. Since the battery unit having a large capacity generates a large amount of heat, the battery unit is provided with a cooling device for cooling the battery.

For example, Japanese Patent No. 6631493 discloses a battery unit disposed below a seat. In order to cool the battery, the battery unit is provided with a cooling fan which sucks air in a vehicle interior and sends the air into the battery unit.

When the cooling fan is driven, intake noise leaks from an intake port of the battery unit. If the intake noise of the cooling fan leaking from the intake port is large, the noise may cause discomfort to an occupant.

### SUMMARY

The present disclosure provides a battery unit in which intake noise of a fan leaking from an intake port can be reduced. Further, the present disclosure contributes to improvement in efficiency of energy.

According to an aspect of the present disclosure, there is provided a battery unit mounted on a vehicle, the battery unit including: a case having an intake port; a battery module which is disposed inside the case and in which a plurality of battery cells are stacked; a fan disposed inside the case and blowing cooling air to the battery module; and an intake duct connecting the intake port and the fan, in which the intake duct includes: a first flow path extending along a first surface of the battery module; and a second flow path extending along a second surface different from the first surface of the battery module.

According to the present disclosure, it is possible to reduce the intake noise of the fan leaking from the intake port.

### BRIEF DESCRIPTION OF DRAWINGS

FIG. 1 is a perspective view of a periphery of a rear seat RS of a vehicle V on which a battery unit 10 according to an embodiment of the present disclosure is mounted.

FIG. 2 is an exploded perspective view of the battery unit 10 according to the embodiment of the present disclosure.

FIG. 3 is a view illustrating a flow of a cooling gas from an intake port 61 of a cover 60 to an outlet of an inter-cell flow path 11a of a battery module 11.

FIG. 4 is a cross-sectional view taken along a line A-A in FIG. 1, illustrating a flow of the cooling gas from the outlet of the inter-cell flow path 11a of the battery module 11 to the outside of the battery unit 10.

FIG. 5 is a schematic view illustrating a configuration of an intake duct 30.

### DESCRIPTION OF EMBODIMENTS

Hereinafter, an embodiment of a battery module of the present disclosure will be described with reference to the accompanying drawings. Note that the drawings are to be viewed according to orientation of the reference signs. In the present specification and the like, in order to simplify and clarify the description, a front-rear direction, a left-right direction, and an up-down direction are described in accordance with directions viewed from a driver of a vehicle. In the drawings, a front side of the vehicle is denoted by Fr, a rear side thereof is denoted by Rr, a left side thereof is denoted by L, a right side thereof is denoted by R, an upper side thereof is denoted by U, and a lower side thereof is denoted by D.

### Vehicle

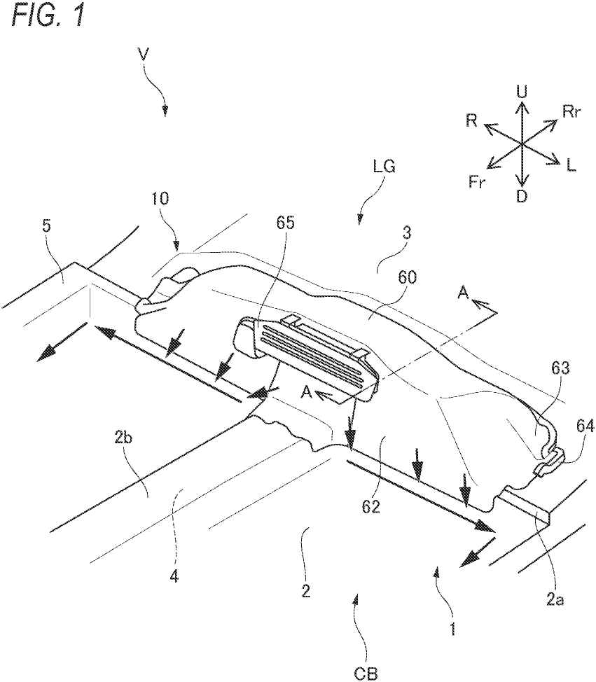

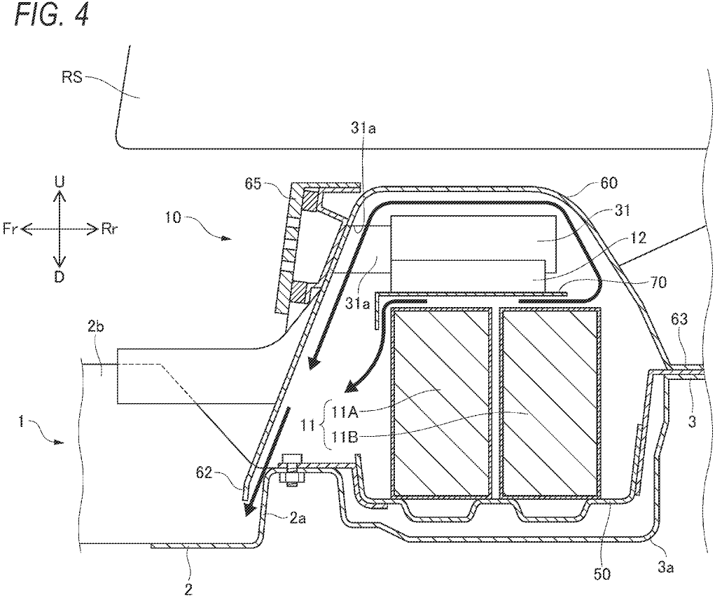

As illustrated in FIG. 1, a battery unit 10 of the present embodiment is mounted on a vehicle V The vehicle V is an electric vehicle such as a hybrid vehicle or an electric automobile, and is configured to be able to travel by driving a motor with electric power stored in the battery unit 10. The battery unit 10 is mounted on a floor panel 1 and fixed to the floor panel 1. A rear seat RS of the vehicle V is disposed above the battery unit 10 (see FIG. 4).

The floor panel 1 includes a front floor panel 2 which constitutes a floor of a vehicle cabin CB, and a rear floor panel 3 which constitutes a floor or the like of a luggage compartment LG provided behind the vehicle cabin CB. The front floor panel 2 and the rear floor panel 3 are connected below the rear seat RS. Both ends of the floor panel 1 in a vehicle width direction are connected to a pair of left and right frame members 5 extending along the front-rear direction, whereby the floor panel 1 is fixed to the frame members 5.

A kick-up portion 2a which rises upward is formed at a rear end of the front floor panel 2. A center tunnel 2b is formed along the front-rear direction at a center portion of the front floor panel 2 in the vehicle width direction. The center tunnel 2b is bent such that the front floor panel 2 protrudes upward, and a trapezoidal tunnel space 4 is formed below the center tunnel 2b.

### Overall Configuration of Battery Unit

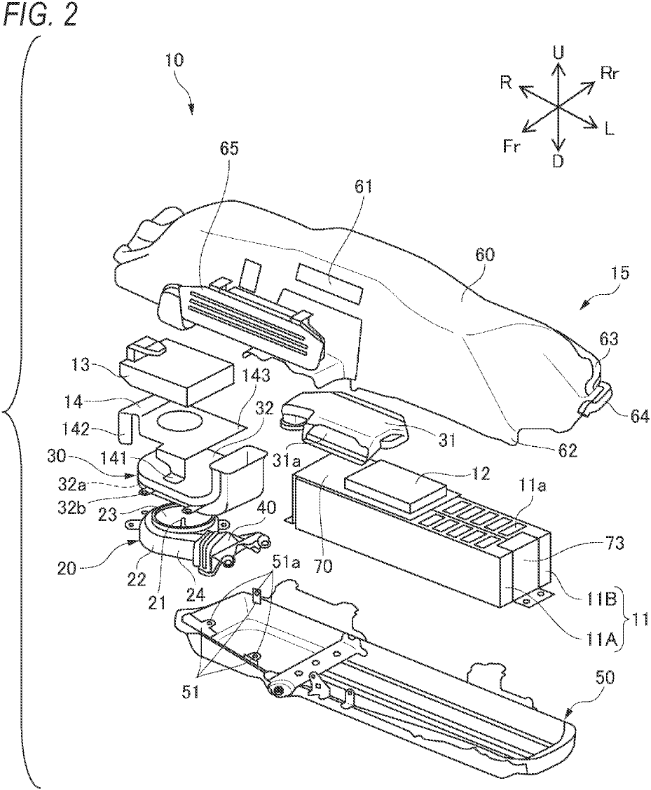

As illustrated in FIG. 2, the battery unit 10 includes a battery module 11, a fan 20 which blows out a cooling gas for cooling the battery module 11, an intake duct 30 through which the cooling gas is introduced into the fan 20, an air feeding duct 40 through which the cooling gas blown out from the fan 20 is sent out in a desired direction, a battery control device 12 which controls charging and discharging of the battery module 11, ajunction board 13 which electrically connects the battery module 11 and an external device (not illustrated) and on which wiring components through which charging electric power and discharging electric power of the battery module 11 flow are mounted, and a case 15 which accommodates these members. The fan 20, the intake duct 30, the air feeding duct 40, the battery control device 12, and the junction board 13 are provided at a position where at least a part thereof overlaps the battery module 11 as viewed in the vehicle width direction.

The case 15 includes a base plate 50 on which the battery module 11, the fan 20, and the air feeding duct 40 are mounted, and a cover 60 which covers the base plate 50 from above. An accommodating recess 3a extending in the vehicle width direction is provided in a front end of the rear floor panel 3 (see FIG. 4), and the base plate 50 is accommodated in the accommodating recess 3a. The cover 60 covers the base plate 50 and is fixed to the floor panel 1. An intake port 61 is formed in a front surface of the cover 60, and the intake port 61 is covered with a grille 65 through which air can pass.

The battery module 11 includes a front battery module 11A disposed at a front side and a rear battery module 11B disposed at a rear side. The battery modules 11A and 11B each have a substantially rectangular parallelepiped shape elongated in the vehicle width direction, and are mounted on the base plate 50 so as to face each other in the front-rear direction. Hereinafter, when the front battery module 11A and the rear battery module 11B are not distinguished from each other, the front battery module 11A and the rear battery module 11B are collectively referred to as the battery module 11.

The battery module 11 includes a plurality of battery cells stacked in the vehicle width direction. An inter-cell flow path 11a is formed between adjacent battery cells, and the cooling gas flows through the inter-cell flow path 11a to cool the battery module 11.

The fan 20 is fixed to the base plate 50. The fan 20 includes an impeller 21 which takes in the cooling gas from a rotation axis direction and blows out the cooling gas in a centrifugal direction, and a fan case 22 which pivotally supports the impeller 21 and accommodates the impeller 21. The fan case 22 includes a suction port 23 through which the cooling gas supplied to the impeller 21 is sucked in, and an air blow-out port 24 through which the cooling gas blown out from the impeller 21 is discharged. In the present embodiment, a rotation axis of the impeller 21 extends in the up-down direction. The fan case 22 has a substantially columnar shape extending in the up-down direction. The suction port 23 is open to the upper side. The air blow-out port 24 protrudes leftward from the substantially columnar fan case 22 and is open to the left side. Therefore, the fan 20 sucks the cooling gas above from the suction port 23 and sends out the cooling gas leftward from the air blow-out port 24.

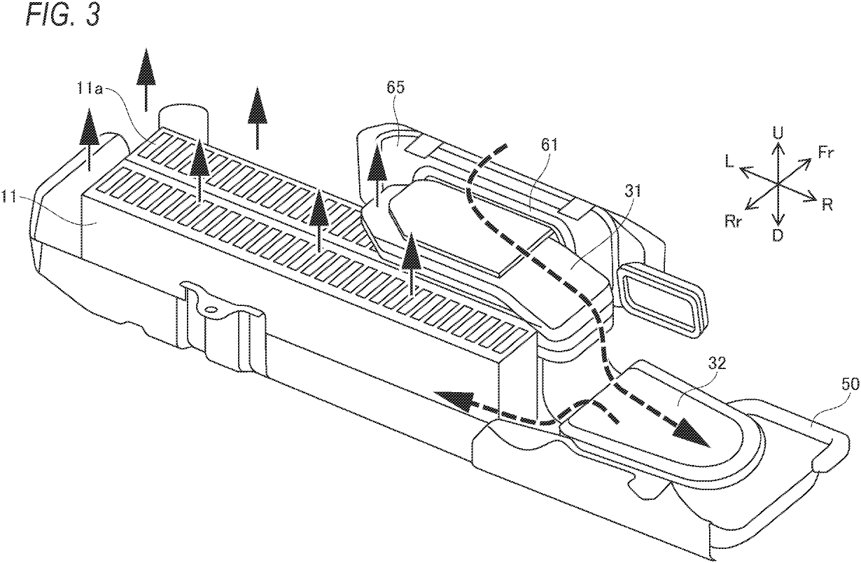

As illustrated in FIGS. 2 and 3, the intake duct 30 connects the intake port 61 of the cover 60 and the suction port 23 of the fan 20, and guides air in the vehicle cabin CB as the cooling gas from the intake port 61 to the fan 20. The intake duct 30 includes an upstream intake duct 31 which is connected to the intake port 61 and disposed above the battery module 11, and a downstream intake duct 32 which is connected to the suction port 23 and disposed on the right side of the battery module 11. The upstream intake duct 31 and the downstream intake duct 32 are connected to each other, and flow paths thereof communicate with each other. Details of the intake duct 30 will be described later.

The air feeding duct 40 is provided between the battery module 11 and the fan 20, and is connected to the air blow-out port 24 of the fan 20. As illustrated in FIG. 3, the air feeding duct 40 sends out the cooling gas blown out from the air blow-out port 24 along a lower surface of the battery module 11.

The cooling gas sent out to a lower side of the battery module 11 flows from a lower side to an upper side in the inter-cell flow path 11a, cools the battery module 11, and is discharged from an upper surface of the battery module 11. Thereafter, as illustrated in FIG. 4, the cooling gas flows inside the case 15 toward a gap formed between a front end 62 of the cover 60 and the floor panel 1. Then, the cooling gas is discharged to the outside of the case 15 as indicated by an arrow in FIG. 1. A seal member 64 is provided at a gap formed between a rear end 63 of the cover 60 and the floor panel 1, and is configured such that the cooling gas is not discharged to a rear floor panel 3 side. The seal member 64 is made of, for example, an elastic material such as rubber.

The battery control device 12 is mounted on a bracket 70 attached to the battery module 11, and is disposed between the upstream intake duct 31 and the battery module 11. Accordingly, the cooling gas flowing through the inter-cell flow path 11a from the lower side to the upper side comes into contact with the battery control device 12. Therefore, it is possible to prevent the cooling gas, which received heat from the battery module 11, from directly coming into contact with the upstream intake duct 31 and raising a temperature of an intake gas. The battery control device 12 is implemented by an electronic control unit (ECU) including a processor, a memory, an interface, and the like.

A lower end of the bracket 70 is fixed to the base plate 50, and the battery module 11 is fixed to the base plate 50 via the bracket 70. As illustrated in FIG. 2, a bracket 73 for fixing the battery module 11 is separately provided on a left surface of the battery module 11, and the battery module 11 is fixed to the base plate 50 via the bracket 73.

The junction board 13 is disposed above the downstream intake duct 32. More specifically, the junction board 13 is mounted on a junction board bracket 14 provided above the downstream intake duct 32.

The junction board bracket 14 is fixed to the base plate 50. Specifically, the junction board bracket 14 is fixed to a bottom wall and side walls of the base plate 50 at a front left fixing portion 141, a front right fixing portion 142, and a rear left fixing portion 143. For example, each of the front left fixing portion 141, the front right fixing portion 142, and the rear left fixing portion 143 has a through hole, and is fixed to the base plate 50 by a fastening member such as a bolt inserted through the through hole. A configuration of the junction board bracket 14 for being fixed to the base plate 50 is not limited thereto, and may be implemented by welding or the like. In addition, a fixing position or a fixing place is not limited thereto, and may be freely designed.

### Intake Duct

Next, the details of the intake duct 30 will be described.

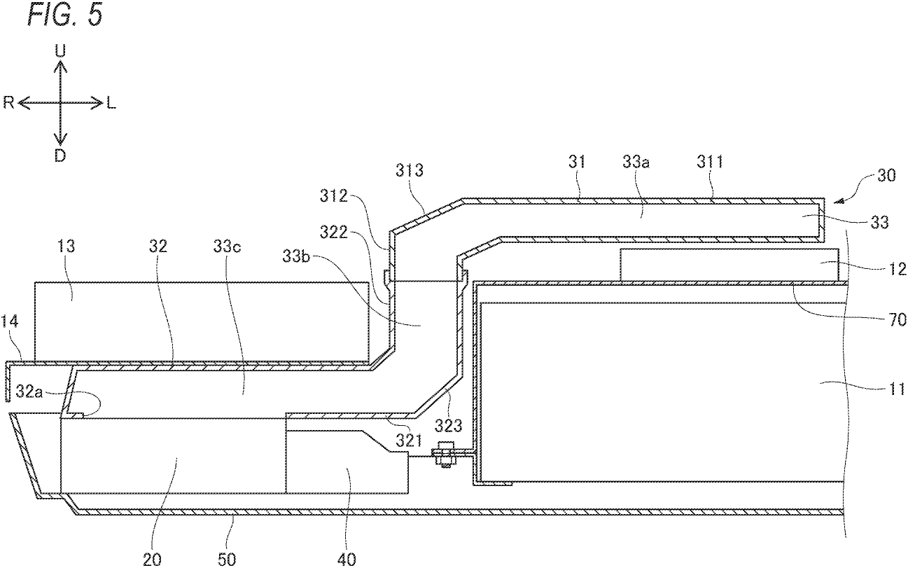

As illustrated in FIGS. 2 and 5, the upstream intake duct 31 is a substantially L-shaped duct in a front view. The upstream intake duct 31 is provided with an intake port connection portion 31a which is open to the front side, and the intake port connection portion 31a is connected to the intake port 61 from an inner side of the cover 60.

The upstream intake duct 31 includes a horizontal portion 311 extending in a horizontal direction (in the embodiment, the vehicle width direction) along the upper surface of the battery module 11, a vertical portion 312 extending in a vertical direction along a right surface of the battery module 11, and a bent portion 313 connecting the horizontal portion 311 and the vertical portion 312. A lower end of the vertical portion 312 is open to the lower side and is connected to the vertical portion 322 of the downstream intake duct 32 to be described later. The bent portion 313 changes a traveling direction of the cooling gas flowing in the horizontal portion 311 from the horizontal direction to the vertical direction, and guides the cooling gas to the vertical portion 312.

The downstream intake duct 32 is a substantially L-shaped duct in a front view. The downstream intake duct 32 is provided with a fan connection portion 32a which is open to the lower side, and the fan connection portion 32a is connected to the suction port 23 of the fan 20 from above.

The downstream intake duct 32 includes three duct-side fixing portions 32b at a front right portion, a front left portion, and a rear right portion (in FIG. 2, the duct-side fixing portion 32b at the rear right portion is omitted). The base plate 50 has three intake duct brackets 51 provided at positions corresponding to the three duct-side fixing portions 32b, and each intake duct bracket 51 is provided with a base-plate-side fixing portion 51a. When the duct-side fixing portions 32b are fixed to the base-plate-side fixing portions 51a by clips (not illustrated), the downstream intake duct 32 is fixed to the base plate 50.

Specifically, through holes are formed in the duct-side fixing portions 32b and the base-plate-side fixing portions 51a. The clip has a pin shape which can be inserted into the through hole. When the clip is inserted into the through hole from above, the duct-side fixing portion 32b and the base-plate-side fixing portion 51a are fixed to each other, that is, the downstream intake duct 32 is fixed to the base plate 50. However, the fixing of the downstream intake duct 32 to the base plate 50 is not limited thereto. For example, in a case of structure in which the base-plate-side fixing portion 51a extends upward and the duct-side fixing portion 32b has a tubular clip, the downstream intake duct 32 may be fixed to the base plate 50 by inserting the clip into the base-plate-side fixing portion 51a from above. With such a simple configuration in which the clip is inserted from above, the downstream intake duct 32 can be disposed above the fan 20 and fixed to the base plate 50, and accordingly the assembling is easy.

The downstream intake duct 32 includes a horizontal portion 321 extending in the horizontal direction (in the embodiment, the vehicle width direction) above the fan 20, a vertical portion 322 extending in the vertical direction along the right surface of the battery module 11, and a bent portion 323 connecting the horizontal portion 321 and the vertical portion 322. An upper end of the vertical portion 322 is open to the upper side and is connected to the vertical portion 312 of the upstream intake duct 31. The bent portion 323 changes the traveling direction of the cooling gas flowing in the vertical portion 322 from the vertical direction to the horizontal direction, and guides the cooling gas to the horizontal portion 321.

Inside the intake duct 30 configured as described above, an intake flow path 33 extending from the intake port 61 of the cover 60 to the suction port 23 of the fan 20 is formed. The intake flow path 33 includes an intake flow path 33a extending in the horizontal direction along the upper surface of the battery module 11, an intake flow path 33b extending in the vertical direction along the right surface of the battery module 11, and an intake flow path 33c extending in the horizontal direction above the fan 20. Here, the intake flow path 33a corresponds to an internal space of the horizontal portion 311 of the upstream intake duct 31. The intake flow path 33b corresponds to an internal space of the vertical portion 312 of the upstream intake duct 31 and an internal space of the vertical portion 322 of the downstream intake duct 32. The intake flow path 33c corresponds to an internal space of the horizontal portion 321 of the downstream intake duct 32.

While the fan 20 is driven, intake noise is generated by the fan 20. The intake noise of the fan 20 includes, for example, a driving sound generated when the fan 20 is driven and a fluid sound generated when the cooling gas flows. The intake flow path 33 in the intake duct 30 extends along the right surface and the upper surface of the battery module 11, and a bent portion is present between the fan 20 and the intake port 61 of the cover 60. For example, a sound wave of the intake noise has a traveling direction changed while being repeatedly reflected by an inner surface of the intake duct 30 at the bent portion 313 and the bent portion 323, and the acoustic energy of the intake noise attenuates each time the sound wave is reflected. Therefore, since the intake duct 30 sufficiently attenuates the acoustic energy of the intake noise between the fan 20 and the intake port 61, the intake noise leaking into the vehicle cabin CB can be reduced. Therefore, the intake noise leaking into the vehicle cabin CB can be prevented from causing discomfort to the occupant as noise.

It is preferable to provide a sound absorbing material (not illustrated) on the inner surface of the intake duct 30. The sound absorbing material absorbs the acoustic energy of the intake noise propagating through the intake flow path 33 of the intake duct 30. By providing the sound absorbing material, it is possible to further reduce the intake noise leaking from the intake port 61 to the vehicle cabin CB when the fan 20 is driven. The sound absorbing material may be provided on only a part of the inner surface of the intake duct 30 or may be provided on the entire inner surface of the intake duct 30.

In the present embodiment, since the intake duct 30 extends along the upper surface and the right surface of the battery module 11, the intake duct 30 also functions as a crushable zone which protects the battery module 11 at the time of a collision of the vehicle V. That is, at the time of a collision or the like of the vehicle V, the intake duct 30 is easily deformed to absorb impact energy, and the impact energy applied to the battery module 11 can be reduced.

For example, the intake flow path 33b of the intake duct 30 is disposed so as to be sandwiched between the junction board 13 and the battery module 11 in the vehicle width direction of the vehicle V. Therefore, when a load of a side collision is applied to the battery unit 10 from a junction board 13 side, the intake flow path 33b becomes a crushable zone and absorbs impact energy. In addition, since the intake flow path 33b extends in the vertical direction, the crushable zone is formed to be wide in the vertical direction. Therefore, the impact energy applied to the battery module 11 from a lateral side can be reduced, and damage to the battery module 11 can be prevented.

In addition, at the time of a head-on collision of the vehicle V or the like, the rear seat RS positioned above the battery unit 10 may sink, and a load may be applied to the battery module 11 from above. Since the intake flow path 33a of the intake duct 30 is disposed above the battery module 11, the intake flow path 33a becomes a crushable zone and absorbs impact energy. Therefore, the impact energy applied to the battery module 11 from above can be reduced, and damage to the battery module 11 can be prevented.

Although one embodiment of the present invention has been described above with reference to the accompanying drawings, it is needless to say that the present invention is not limited to the embodiment. It is apparent that those skilled in the art can conceive various modifications and alterations within the scope described in the claims, and it is also understood that such modifications and alterations naturally fall within the technical scope of the present invention. In addition, constituent elements in the above embodiment may be freely combined without departing from the gist of the invention.

For example, in the above embodiment, the intake duct 30 has the flow path extending along the upper surface and the right surface of the battery module 11, and the present invention is not limited thereto. The intake duct 30 may have a flow path extending along at least two surfaces of the battery module 11, and may have a flow path extending along a front surface, a rear surface, the left surface, or the lower surface of the battery module 11.

In the above embodiment, the intake duct 30 forms the intake flow path 33 by the upstream intake duct 31 and the downstream intake duct 32, and the present invention is not limited thereto. In the intake duct 30, the intake flow path 33 may be formed of a single member, or the intake flow path 33 may be formed of three or more members.

In the above embodiment, in order to fix the downstream intake duct 32 to the base plate 50, the base-plate-side fixing portion 51a of the intake duct bracket 51 and the duct-side fixing portion 32b of the downstream intake duct 32 are fixed to each other by clips, and the present invention is not limited thereto. For example, since the junction board bracket 14 is disposed above the downstream intake duct 32 and the fan 20, the junction board bracket 14 may be fixed to the base plate 50 by pressing the downstream intake duct 32 against the fan 20. With this configuration as well, the downstream intake duct 32 can be fixed to the fan 20. In such a configuration, since the junction board bracket 14 can be used for fixing the downstream intake duct 32 and the fan 20, it is not necessary to separately provide a fastening member such as a bolt or a nut at the time of fixing.

In the above embodiment, the junction board bracket 14 is fixed to the base plate 50, and the present invention is not limited thereto. The junction board bracket 14 may be fixed to the fan 20. With such a configuration as well, the intake duct 30 can be fixed to the fan 20 by being sandwiched between the junction board bracket 14 and the fan 20.

In the present description, at least the following matters are described. In the parentheses, the corresponding constituent elements and the like in the above embodiment are shown as an example, and the present invention is not limited thereto.

(1) A battery unit (battery unit 10) mounted on a vehicle (vehicle V), the battery unit including:
a case (case 15) having an intake port (intake port 61);
a battery module (battery module 11) which is disposed inside the case and in which a plurality of battery cells are stacked;
a fan (fan 20) disposed inside the case and blowing cooling air to the battery module; and
an intake duct (intake duct 30) connecting the intake port and the fan, in which the intake duct includes:
   a first flow path (intake flow path 33a) extending along a first surface of the battery module; and
   a second flow path (intake flow path 33b) extending along a second surface different from the first surface of the battery module.

According to (1), the intake duct includes the first flow path extending along the first surface of the battery module, and the second flow path extending along the second surface different from the first surface of the battery module. Since the flow path in the intake duct is bent between the fan and the intake port, intake noise of the fan is sufficiently reflected in the intake duct, and acoustic energy of the intake noise is attenuated. Therefore, the intake noise leaking from the intake port can be reduced. In addition, since the intake duct extends along the first surface and the second surface of the battery module, a crushable zone is formed around the battery module. Therefore, the intake duct can protect the battery module from a collision of the vehicle.

(2) The battery unit according to (1), in which

the second surface is a side surface of the battery module in a vehicle width direction.

According to (2), since the second flow path of the intake duct extends along the side surface of the battery module in the vehicle width direction, a crushable zone can be formed on a lateral side of the battery module. Therefore, the intake duct can protect the battery module from a side collision of the vehicle.

(3) The battery unit according to (2), further including:
an electrical component (junction board 13) electrically connected to the battery module, in which
the second flow path is disposed so as to be sandwiched between the electrical component and the battery module in the vehicle width direction of the vehicle.

According to (3), since the second flow path of the intake duct is disposed so as to be sandwiched between the electrical component and the battery module in the vehicle width direction of the vehicle, a crushable zone can be formed between the electrical component and the battery module. Therefore, the intake duct can protect the battery module from an impact from a lateral side of the vehicle where the electrical component is disposed.

(4) The battery unit according to (3), in which

the second flow path extends in a vertical direction along the side surface of the battery module in the vehicle width direction.

According to (4), since the second flow path extends in the vertical direction along the side surface of the battery module in the vehicle width direction, a crushable zone can be formed to be wide in the vertical direction.

(5) The battery unit according to any one of (1) to (4), in which:
the case includes a base plate (base plate 50) on which the fan is mounted;
the intake duct is disposed above the fan; and
the intake duct includes a fixing portion (duct-side fixing portion 32b) fixed to the base plate by a clip.

According to (5), since the intake duct has the fixing portion fixed to the base plate by the clip, the intake duct can be fixed to the base plate with a simple configuration. Therefore, the assembling is easy.

(6) The battery unit according to (3) or (4), further including:
a bracket (junction board bracket 14) on which the electrical component is mounted, in which:
the intake duct has a third flow path (intake flow path 33c) disposed above the fan; and
the bracket is disposed above the fan and the third flow path, and presses the intake duct against the fan.

According to (6), the bracket is disposed above the fan and the third flow path, and presses the intake duct against the fan. Therefore, the bracket on which the electrical component is mounted can be used to fix the fan and the intake duct. Therefore, it is not necessary to separately provide a fastening member for fixing the fan and the intake duct.

(7) The battery unit according to any one of (1) to (6), in which

the first surface is an upper surface of the battery module.

According to (7), since the first flow path of the intake duct extends along the upper surface of the battery module in the vehicle width direction, a crushable zone can be formed above the battery module. Therefore, the intake duct can protect the battery module from a load applied from above.

(8) The battery unit according to (7), further including:
a control device (battery control device 12) configured to control charging and discharging of the battery module, in which:
an inter-cell flow path (inter-cell flow path 11a) through which the cooling air sent out from the fan flows from a lower side to an upper side is formed between the battery cells; and
the control device is disposed between the first flow path and the battery module.

According to (8), since the control device is disposed between the first flow path and the battery module, it is possible to prevent a cooling gas, which received heat from the battery module, from directly coming into contact with the intake duct and raising a temperature of an intake gas.

(9) The battery unit according to (7) or (8), in which

the battery unit is disposed below a seat (rear seat RS) provided in the vehicle.

According to (9), even if a load is applied from above due to sinking of the seat at the time of a collision of the vehicle, a crushable zone is formed above the battery module, and thus the battery module can be protected from a load applied from above.

(10) The battery unit according to (1), in which:
the first flow path is connected to the intake port and extends in a horizontal direction along an upper surface of the battery module;
the second flow path is connected to the first flow path and extends in a vertical direction along a side surface of the battery module; and
the intake duct further includes a third flow path (intake flow path 33c) which connects the second flow path and the fan, and the third flow path extending in the horizontal direction above the fan.

According to (10), the intake duct includes the first flow path extending along the upper surface of the battery module, the second flow path extending in the vertical direction along the side surface of the battery module, and the third flow path connecting the second flow path and the fan and extending in the horizontal direction above the fan. Since the flow path in the intake duct is bent between the fan and the intake port, intake noise of the fan is sufficiently reflected in the intake duct, and acoustic energy of the intake noise is attenuated. Therefore, the intake noise leaking from the intake port can be reduced. In addition, since the intake duct extends along the upper surface and the side surface of the battery module, a crushable zone is formed around the battery module. Therefore, the intake duct can protect the battery module from a collision of the vehicle.

What is claimed is:

1. A battery unit mounted on a vehicle, the battery unit comprising:
a case having an intake port;
a battery module which is disposed inside the case and in which a plurality of battery cells are stacked;
a fan disposed inside the case and blowing cooling air to the battery module; and
an intake duct connecting the intake port and the fan, wherein
the intake duct includes:
a first flow path extending along a first surface of the battery module; and
a second flow path extending along a second surface different from the first surface of the battery module.

2. The battery unit according to claim 1, wherein
the second surface is a side surface of the battery module in a vehicle width direction.

3. The battery unit according to claim 2, further comprising:
an electrical component electrically connected to the battery module, wherein
the second flow path is disposed to be sandwiched between the electrical component and the battery module in the vehicle width direction of the vehicle.

4. The battery unit according to claim 3, wherein
the second flow path extends in a vertical direction along the side surface of the battery module in the vehicle width direction.

5. The battery unit according to claim 1, wherein:
the case includes a base plate on which the fan is mounted;
the intake duct is disposed above the fan: and
the intake duct includes a fixing portion fixed to the base plate by a clip.

6. The battery unit according to claim 3, further comprising:
a bracket on which the electrical component is mounted, wherein:
the intake duct has a third flow path disposed above the fan; and
the bracket is disposed above the fan and the third flow path, and presses the intake duct against the fan.

7. The battery unit according to claim 1, wherein
the first surface is an upper surface of the battery module.

8. The battery unit according to claim 7, further comprising:
a control device configured to control charging and discharging of the battery module, wherein:
an inter-cell flow path through which the cooling air sent out from the fan flows from a lower side to an upper side is formed between the battery cells; and
the control device is disposed between the first flow path and the battery module.

9. The battery unit according to claim 7, wherein
the battery unit is disposed below a seat provided in the vehicle.

10. The battery unit according to claim 1, wherein:
the first flow path is connected to the intake port and extends in a horizontal direction along an upper surface of the battery module;
the second flow path is connected to the first flow path and extends in a vertical direction along a side surface of the battery module; and
the intake duct further includes a third flow path which connects the second flow path and the fan, the third flow path extending in the horizontal direction above the fan.
